(19) United States
(12) Patent Application Publication
(10) Pub. No.: US 2005/0110378 A1
(43) Pub. Date: May 26, 2005

(54) Surface light source device, method of manufacturing the same and display apparatus having the same

(76) Inventors: Hyeon-Yong Jang, Osan-si (KR); Hyoung-Joo Kim, Uiwang-si (KR); Jin-Seob Byun, Seoul (KR); Geun-Young Kim, Seoul (KR); Sang-Yu Lee, Yongin-si (KR); Joong-Hyun Kim, Yongin-si (KR)

Correspondence Address: McGuireWoods, Suite 1800, 1750 Tysons Boulevard, McLean, VA, 22102-4215, US

(21) Appl. No.: 10/956,037

(22) Filed: Oct. 4, 2004

(30) Foreign Application Priority Data
Nov. 20, 2003 (KR) 2003-82480

(51) Int. Cl. H01J 1/00

(52) U.S. Cl. 313/1

(57) ABSTRACT

A surface light source device includes a body, a partition member, a first providing member and a visible light generating unit. The body includes a first substrate having first main and sub regions alternatingly formed with each other, and a second substrate having second main and sub regions facing the first main and sub regions, respectively. The partition member is interposed between the first and second sub regions to form discharge spaces between the first and second main regions. The partition member has a passage connecting between the discharge spaces. The first providing member is disposed on the passage, and the providing member provides the discharge space with operation gas. The visible light generating unit generates a visible light from the operation gas of the discharge spaces. Therefore, process of manufacturing the surface light source device is simplified to enhance productivity.

### CROSS-REFERENCE TO RELATED APPLICATIONS

This application relies for priority upon Korean Patent Application No. 2003-82480 filed on Nov. 20, 2003, the contents of which are herein incorporated by reference in its entirety.

### BACKGROUND OF THE INVENTION

1. Field of the Invention

The present invention relates to a surface light source device, a method of manufacturing the surface light source device and a display apparatus having the surface light source device. More particularly, the present invention relates to a surface light source device capable of simplifying a manufacturing process and having a long life span, a method of manufacturing the surface light source device and a display apparatus having the surface light source device.

2. Description of the Related Art

A display apparatus converts data processed by an information processing apparatus into images. A liquid crystal display apparatus that is one of the display apparatuses displays images by using liquid crystal.

An arrangement of the liquid crystal varies in accordance with electric fields. When the arrangement of the liquid crystal is changed, an optical transmittance of the liquid crystal is also adjusted.

Accordingly, the liquid crystal display apparatus uses above described electrical and optical characteristics to display images. The liquid crystal display apparatus has small volume and lightweight in comparison with a cathode ray tube (CRT), so that the liquid crystal display apparatus is widely used for a mobile computer, a communication device, a liquid crystal television receiver, etc.

The liquid crystal display apparatus includes a liquid crystal controlling part and a light providing part. The liquid crystal display apparatus controls liquid crystal, and the light providing part provides the liquid crystal controlling part with a light.

The liquid crystal controlling part includes first and second electrodes spaced apart from each other. Electric fields are generated between the first and second electrodes to change the arrangement of the liquid crystal. The first electrode is electrically connected to a thin film transistor, so that pixel voltages having various levels are applied to the first electrode. A reference voltage is applied to the second electrode.

The light proving part provides the liquid crystal controlling part with a light. The light generated from the light providing part passes through the first electrode, liquid crystal and the second electrode in that sequence to display images. Therefore, a display quality is influenced by uniformity of the light generated from the light providing part.

Examples of a conventional light proving part are a cold cathode fluorescent lamp (CCFL) and a light emitting diode (LED). The CCFL has high luminance and long lifespan. Additionally, the CCFL generates a white light, and the CCFL generates a less heat compared to a glow lamp. The LED has low power consumption and high luminance.

However, the CCFL and the LED have low uniformity of luminance.

Therefore, the conventional light providing part requires a light guide plate (LGP), a diffusion member, a prism sheet, etc., thereby increasing volume, weight and manufacturing cost of the liquid crystal display apparatus.

### SUMMARY OF THE INVENTION

The present invention provides a surface light source device capable of simplifying a manufacturing process and having a long life span.

The present invention also provides a method of manufacturing the surface light source device.

The present invention still also provides a display apparatus having the surface light source device.

In an exemplary surface light source device according to the present invention, the surface light source device includes a body, a partition member, a first providing member and a visible light generating unit. The body includes a first substrate having a first main region and a first sub region, which are alternating with each other, and a second substrate having a second main region facing the first main region and a second sub region facing the first sub region. The partition member is interposed between the first and second sub regions to form discharge spaces between the first and second main regions. The partition member has a passage that connects the discharge spaces. The first providing member is disposed on the passage, and the providing member provides the discharge space with operation gas. The visible light generating unit generates a visible light from the operation gas of the discharge spaces.

In an exemplary method of manufacturing the surface light source device according to the present invention, a first substrate having a first main region and a first sub region alternating with each other is formed. A second substrate having a second main region facing the first main region, and a second sub region facing the first sub region are formed. A partition member is formed on the second sub region to form discharge spaces corresponding to the first and second main regions. The partition member has a passage connecting the discharge spaces. A providing member disposed at the passage is formed. The providing member provides the discharge spaces with operation gas. Then, the first and second substrates are assembled together.

In an exemplary display apparatus according to the present invention, the display apparatus includes a surface light source device and a display panel. The surface light source device includes a body, a partition member, a providing member and a visible light generating member. The body has a space. The partition member is disposed in the space to form a plurality of discharge spaces and the partition member has a passage connecting the discharge spaces. The providing member is disposed at the passage and the providing member provides the discharge spaces with operation gas. The visible light generating unit generates a visible light from the operation gas of the discharge space. The display panel converts the visible light generated from the surface light source device into an image light containing information.

According to the present invention, an opening for providing operation gas to a discharge space and sealing process after the operation gas is provided are not required. Therefore, process of manufacturing the surface light source device may be simplified to enhance productivity.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is an exploded perspective view illustrating a surface light source device according to a first exemplary embodiment of the present invention;

FIG. 2 is an enlarged view of ‘A’ in FIG. 1;

FIG. 3 is partially cutout perspective view illustrating a providing member spaced apart from a second substrate in FIG. 1;

FIG. 4 is a cross-sectional view illustrating an exemplary combination structure of a providing member and a body in FIG. 1;

FIG. 5 is a cross-sectional view illustrating another exemplary combination structure of a providing member and a body in FIG. 1;

FIG. 6 is a plan view illustrating a combination structure of a providing member and a partition member in FIG. 1;

FIG. 7 is a cross-sectional view taken along a line I-I′ in FIG. 1;

FIG. 8 is a plan view illustrating a providing member and a partition member according to a second exemplary embodiment of the present invention;

FIGS. 9A to 9G are cross-sectional views illustrating a process of manufacturing a surface light source device according to a third exemplary embodiment of the present invention;

FIGS. 10A to 10C are cross-sectional views illustrating a process of manufacturing a surface light source device according to a fourth exemplary embodiment of the present invention; and

FIG. 11 is an exploded perspective view illustrating a display apparatus according to a fifth exemplary embodiment of the present invention.

### DESCRIPTION OF PREFERRED EMBODIMENTS

Hereinafter, the preferred embodiments of the present invention will be described in detail with reference to the accompanied drawings.

Surface Light Source Device

Embodiment 1

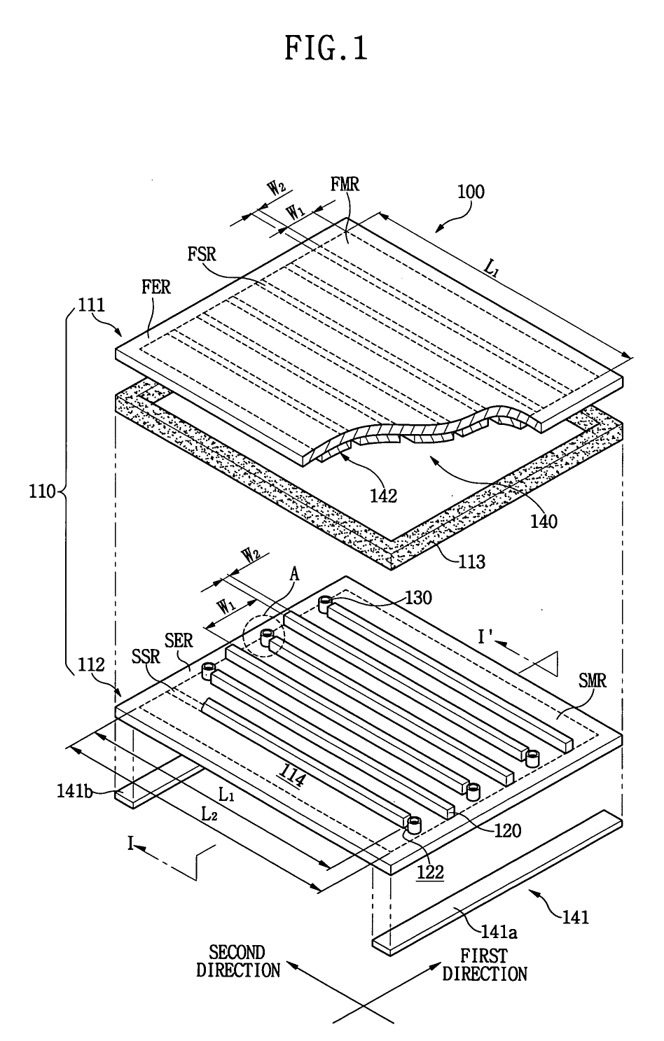

FIG. 1 is an exploded perspective view illustrating a surface light source device according to a first exemplary embodiment of the present invention.

Referring to FIG. 1, a surface light source device 100 includes a body 110, a partition member 120, a providing member 130 and a visible light generating unit 140.

The body 110 includes a first substrate 111 and a second substrate 112. The body 110 may further include a sealing member that is interposed between the first and second substrates 111 and 112 to form a space in the body 110. In the present embodiment, the sealing member 113 is interposed between the first and second substrates 111 and 112.

The first substrate 111 includes a transparent material, and the first substrate 111 has a rectangular plate shape. The first substrate 111 includes a first main region FMR and a first sub region FSR. When the body 110 further includes a sealing member 113, the first substrate 111 further includes a first enclosing region FER. The sealing member 113 is disposed in the first enclosing region FER.

The first main region FMR and the first sub region FSR are alternatingly formed on the first substrate 111, and the first main region FMR is substantially parallel with the first sub region FSR.

The first main region FMR has a first width W1 along a first direction, and the first main region FMR has a first length L1 along a second direction that is substantially perpendicular to the first direction. The first sub region FSR has a second width W2 along the first direction, and the first sub region FSR has a second length L2 along the second direction.

The second substrate 112 includes an optically transparent material, and the second substrate 112 has a rectangular plate shape. The second substrate 112 includes a second main region SMR and a second sub region SSR. When the body 110 includes the sealing member 113, the second substrate further includes a second enclosing region SER that surrounds the second main region SMR and the second sub region SSR. The sealing member 113 is disposed in the second sealing region SER.

The second main region SMR and the second sub region SSR are alternatingly formed on the second substrate 112, and the second main region SMR is substantially parallel with the second sub region SSR.

The second main region SMR has the first width W1 along a first direction, and the second main region SMR has the first length L1 along the second direction. The second sub region SSR has the second width W2 along the first direction, and the second sub region SSR has the second length L2 along the second direction.

The first and second main regions FMR and SMR face each other, and the first and second sub regions FSR and SSR face each other.

The partition member 120 is interposed between the first and second sub regions FSR and SSR. The partition member 120 divides a space formed in the body 110 into plurality of discharge spaces 114. The partition member 120 lowers a discharge voltage to reduce power consumption.

The partition member 120 includes a material such as ceramics, and the partition member 120 has a wall-shape. A passage 122 is formed at one end of the partition member 120. Therefore, the discharge spaces 114 are connected to each other through the passage 122, so that pressure of each discharge space 114 is equalized.

In the present embodiment, in order to form the passage 122, the partition member 120 has a second length L2 that is smaller than the first length L1 of the first and second sub regions FSR and SSR. Therefore, the passage 122 is formed between the sealing member 113 and the partition member 120.

The passage 122 is formed such that the discharge space 114 has a serpentine shape. However, the passage 122 may be disposed along the first direction.

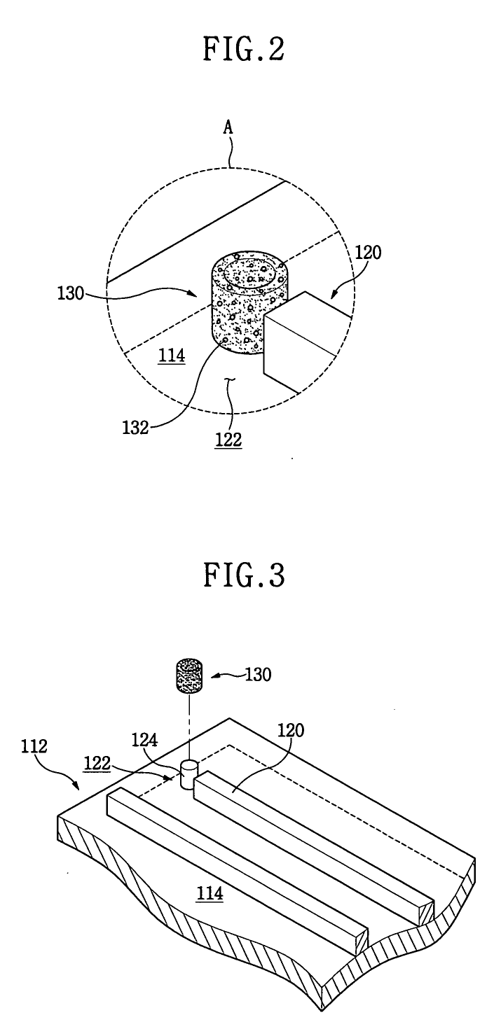

FIG. 2 is an enlarged view of ‘A’ in FIG. 1.

Referring to FIG. 2, a providing member 130 disposed at a passage 122 has a ring shape or a cylinder shape, and the providing member 130 provides a discharge space with operation gas. In order to release the operation gas from the providing member 130, the providing member 130 is heated by high frequency.

The operation gas generates an invisible light. The operation gas includes, for example, mercury (Hg), argon (Ar), krypton (Kr), xenon (Xe) and neon (Ne), etc. The operation gas may not include mercury for environment.

In the present embodiment, the providing member 130 is fixed at the passage 122. When the providing member 130 provides the discharge space 114 with the operation gas, the providing member 130 becomes porous, and the operation gas may move to the discharge space 114 through the porosity of the providing member 130.

The discharge space 114 may also include impurity gas such as oxygen (O₂), carbon monoxide (CO), carbon dioxide (CO₂), nitrogen (N₂), hydrogen (H₂), water vapor (H₂O), metal particle, etc. Therefore, the operation gas may chemically react on the impurity gas to reduce an amount of the operation gas. The amount of the operation gas affects a lifespan of the surface light source device 100. When the amount of the operation gas decreases, the lifespan of the surface light source device 100 decreases as well.

In order to prevent shortening of the lifespan of the surface light source device 100, the providing member 130 may further include an absorption member 132. The absorption member 132 absorbs the impurity gas to remove the impurity gas of the discharge space 114.

When the providing member 130 is separated from the passage 122 to be movable inside the discharge space 114, the providing member 130 may induce a critical malfunction of the surface light source device 100, or the providing member 130 may hurt the discharge space 114.

FIG. 3 is partially cutout perspective view illustrating a providing member spaced apart from a second substrate in FIG. 1.

Referring to FIG. 3, a fixing boss 124 for fixing the proving member 130 is formed on the second substrate 112. The fixing boss 124 disposed at the passage 122 is extended from the second substrate 112 toward the first substrate 111. In the present embodiment, the fixing boss 124 and the partition member 120 are formed simultaneously.

The fixing boss 124 may include ceramic composing the partition member 120. However, the fixing boss 124 may include different material from that of the partition member 120.

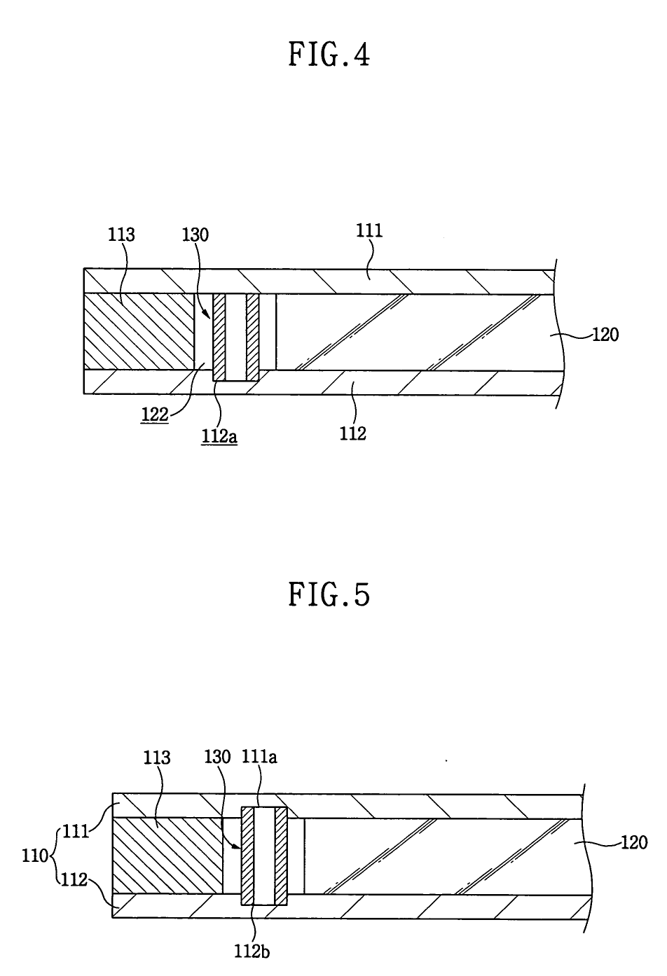

FIG. 4 is a cross-sectional view illustrating an exemplary combination structure of a providing member and a body in FIG. 1.

Referring to FIG. 4, in order to prevent a providing member 130 from being separated from a second substrate 112, the second substrate 112 includes a connection recess 112a formed thereon. The connection recess 112a is disposed at a passage 122 of a second sub region SSR.

The connection recess 112a has a shape and a depth corresponding to the providing member 130. A first end portion of the providing member 130 is compressed by a first substrate 111 so as to be inserted in the receiving recess 112a. Therefore, the proving member 130 is fixed at the second substrate 112.

FIG. 5 is a cross-sectional view illustrating another exemplary combination structure of a providing member and a body in FIG. 1.

Referring to FIG. 5, in order to prevent a providing member 130 from being separated, first and second substrates 111 and 112 include first and second connection recesses 111a and 112a, respectively. The first and second connection recesses 111a and 112a are formed on the first and second substrates 111 and 112, respectively, and the first and second connection recesses 111a and 112a are disposed at a passage 122 of first and second sub regions FSR and SSR, respectively. The first and second connection recesses 111a and 112a face each other.

The first and second connection recesses 111a and 112a have a shape and depth corresponding to the providing member 130. First and second end portions of the providing member 130 are inserted into the first and second receiving recesses 111a and 112a, respectively. Therefore, the proving member 130 is fixed at the first and second substrates 111 and 112.

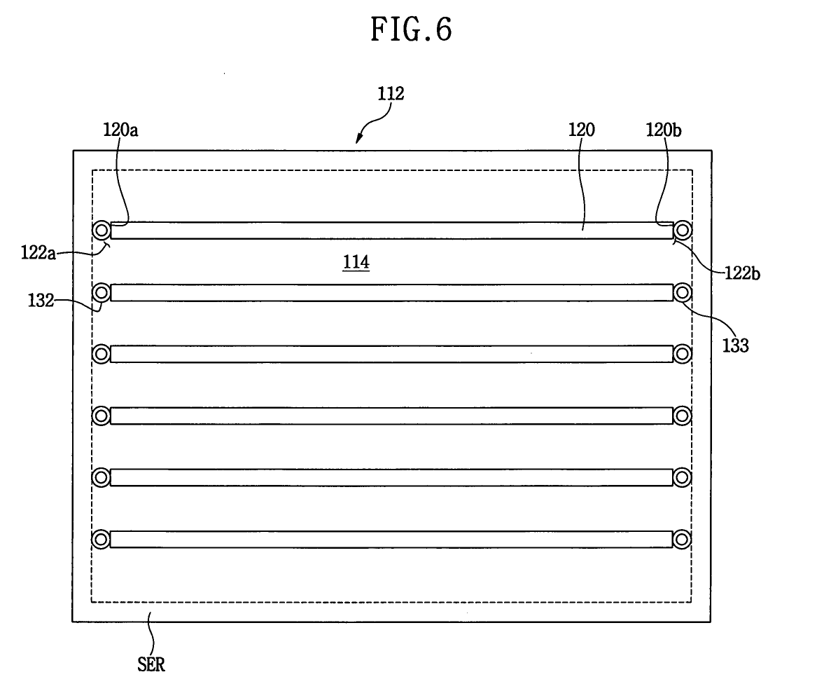

FIG. 6 is a plan view illustrating a combination structure of a providing member and a partition member in FIG. 1.

Referring to FIG. 6, a partition member 120 formed on the second substrate 112 is spaced apart from a second enclosing region SER on which a sealing member 113 is disposed. Therefore, first and second passages 122a and 122b are formed at first and second ends of the partition member 120, respectively. First and second providing members 132 and 133 are disposed at the first and second passages 122a and 122b, respectively.

Referring again to FIG. 1, the visible light generating unit 140 includes a discharge voltage applying member 141 and a first fluorescent layer 142.

The discharge voltage applying member 141 discharges operation gas of the discharge space 114 defined by the partition member 120. The discharge voltage applying unit includes first and second electrodes 141a and 141b.

The first and second electrodes 141a and 141b are disposed on outer surface of the first substrate 111 or the second substrate 112. The first and second electrodes 141a and 141b are extended in the first direction that is substantially perpendicular to the partition member 120. The first and second electrodes 141a and 141b generate electric fields for discharging the operation gas of the discharge space 114.

First and second voltages are applied to the first and second electrodes 141a and 141b, respectively. A voltage difference between the first and second voltages is large enough to emit electrons flowing through the discharge space 114.

When the first and second voltages are applied to the first and second electrodes 141a and 141b, respectively, mercury (Hg) of the operation gas generates an ultraviolet light.

The first fluorescent layer 142 is formed on the first main region FMR of the first substrate 111. The first fluorescent layer 142 converts the ultraviolet light into a visible light, and the visible light exits the first substrate 111.

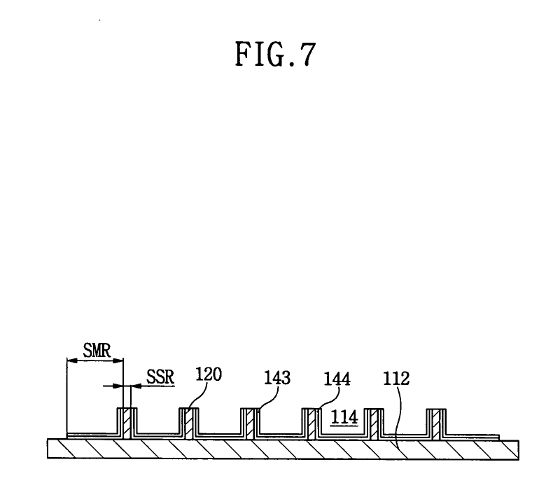

FIG. 7 is a cross-sectional view taken along a line I-I′ in FIG. 1.

Referring to FIG. 7, the visible light generating unit 140 may further include a second fluorescent layer 143. The second fluorescent layer 143 is formed in the second main region SMR of the second substrate 112. The second fluorescent layer 143 converts the invisible light advancing toward the second substrate 112 into a visible light to enhance a luminance.

A light reflection layer 144 is formed between the second substrate 112 and the second fluorescent layer 143. The light reflection layer 144 reflects the visible light generated from the second fluorescent layer 143 toward the first substrate 111 to enhance the luminance.

Embodiment 2

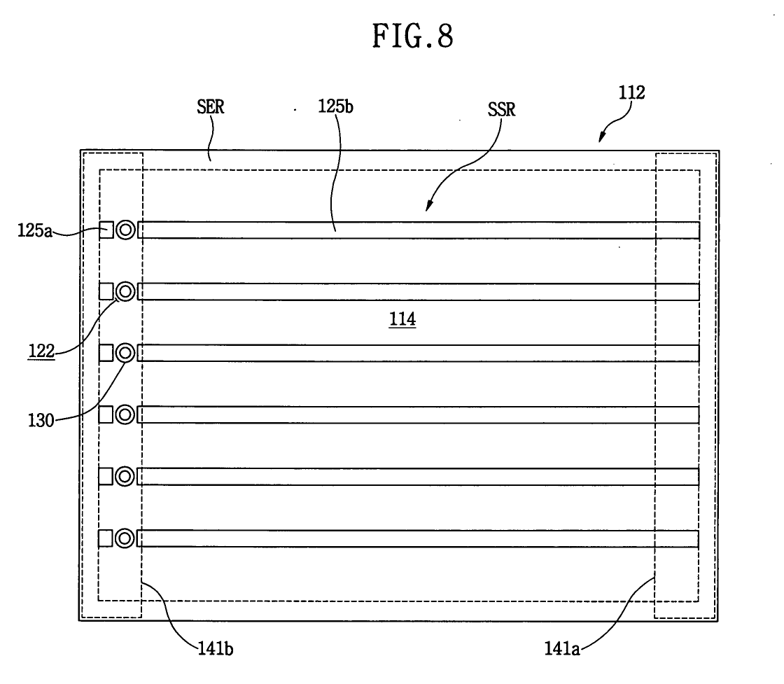

FIG. 8 is a plan view illustrating a providing member and a partition member according to a second exemplary embodiment of the present invention.

Referring to FIG. 8, at least two partition members 125 are disposed in a second sub region SSR. The partition members 125 include a first partition member 125a and a second partition member 125b. First ends of the first and second partition members 125a and 125b, respectively, make contact with a second enclosing region SER, so that a passage 122 is formed between the first and second partition members 125a and 125b. A providing member 130 that provides operation gas to a discharge space 114 is disposed at the passage 122.

The first and second partition members 125a and 125b may have same or different length. In the present embodiment, the first partition member 125a is shorter than the second partition member 125b, so that the partition member 130 is concealed by a discharge voltage applying member 141.

Method of Manufacturing a Surface Light Source Device

Embodiment 3

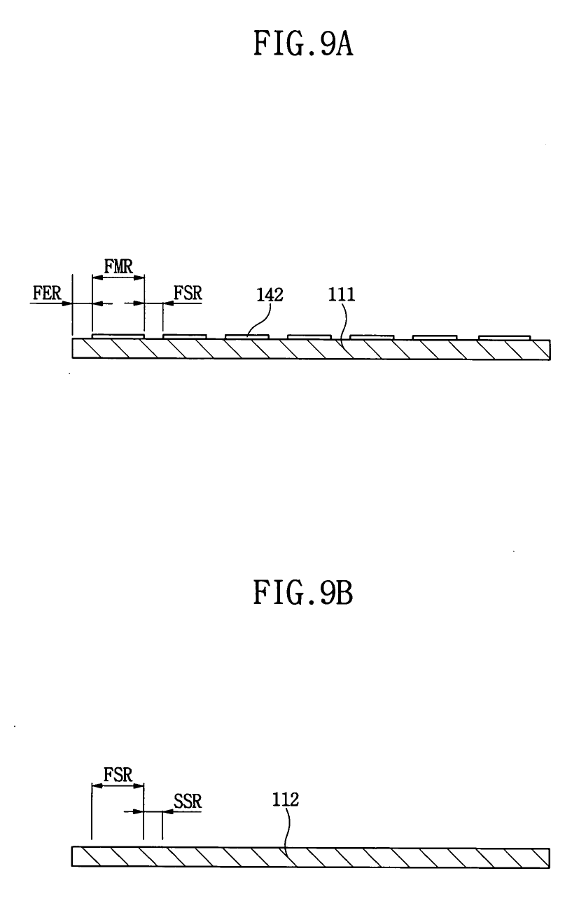

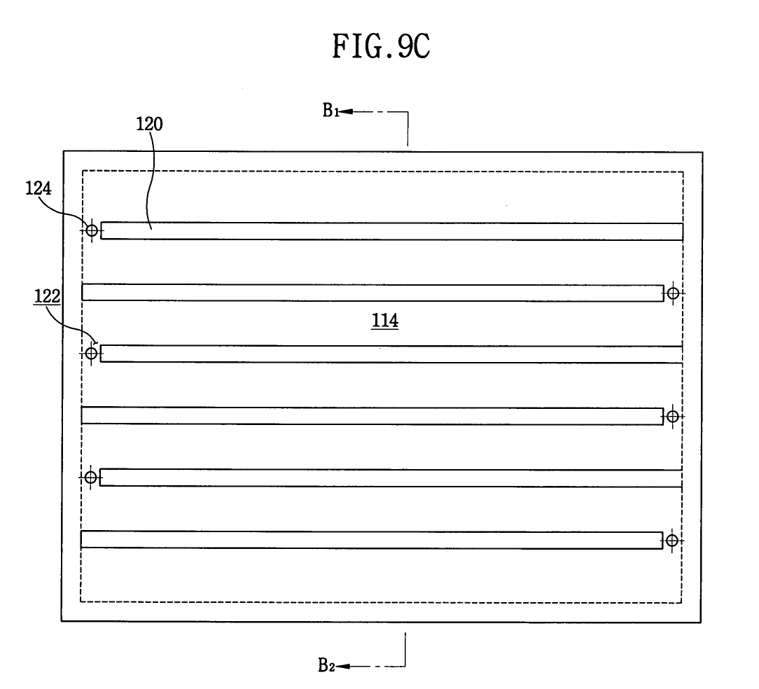

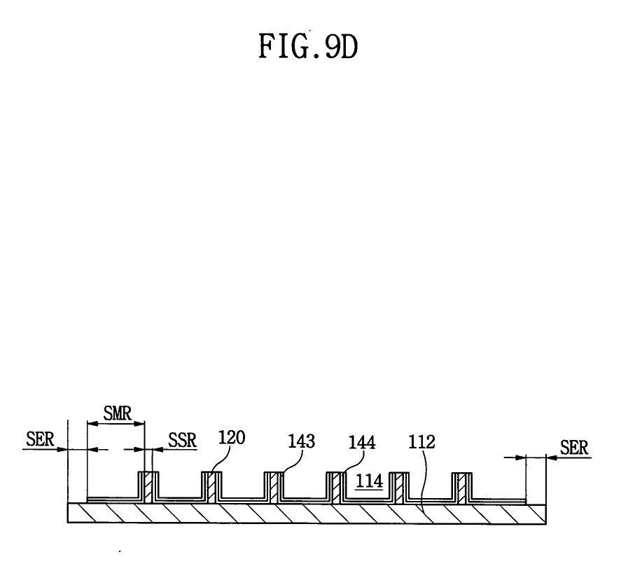

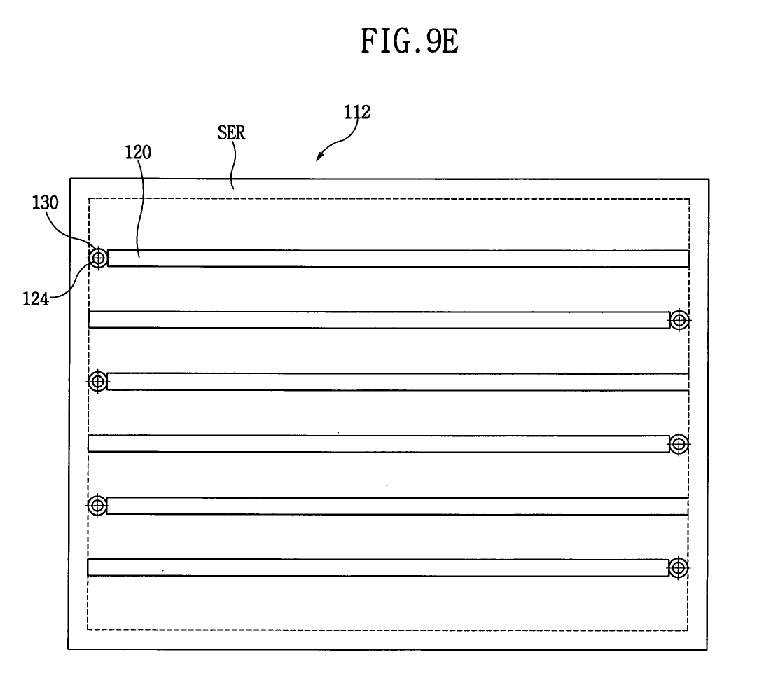

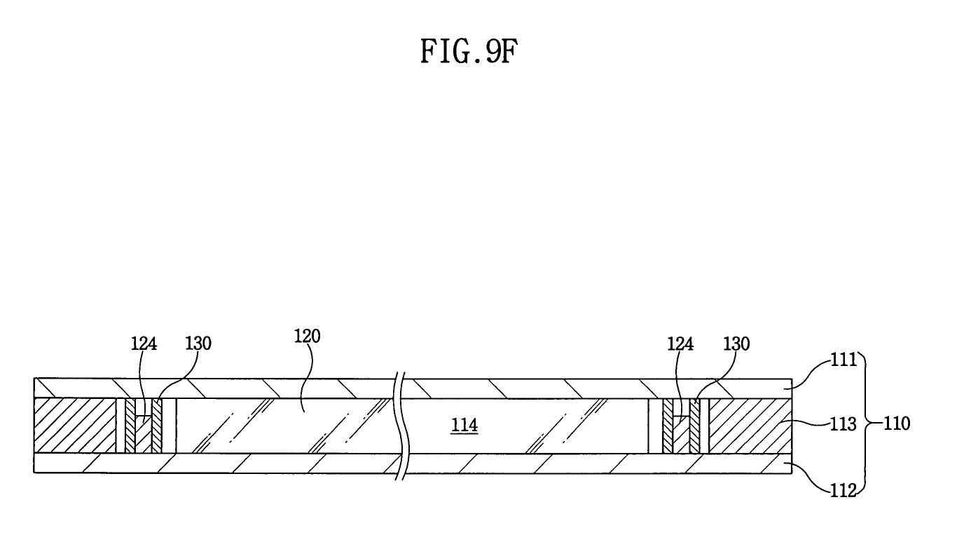

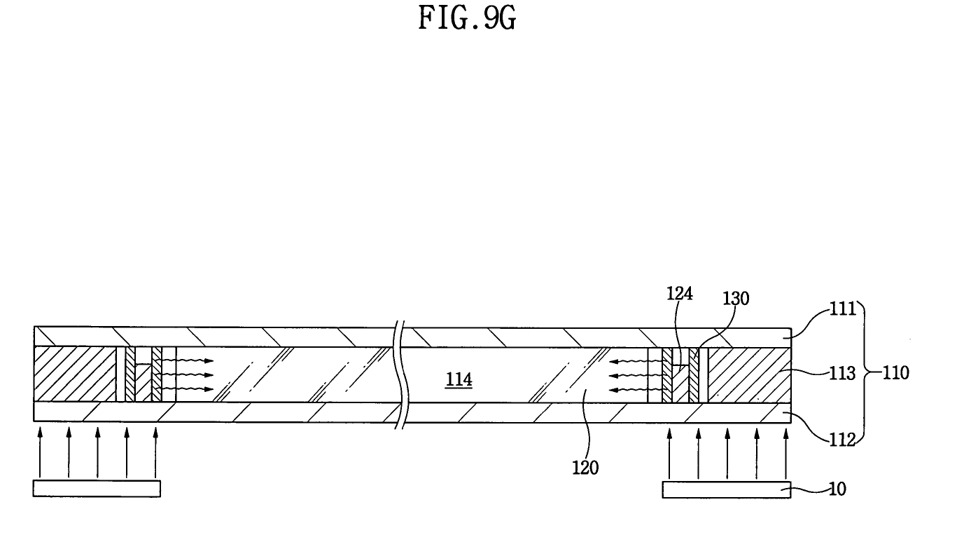

FIGS. 9A to 9G are cross-sectional views illustrating a process of manufacturing a surface light source device according to a third exemplary embodiment of the present invention.

FIG. 9A is a cross-sectional view illustrating a first substrate.

Referring to FIG. 9A, a first substrate 111 including an optically transparent material such as glass is cut out to have a rectangular plate shape.

A first main region FMR and a first sub region FSR are alternatingly formed on a surface of the first substrate 111, and a first fluorescent layer 142 is formed on the first main region FMR. For example, the first fluorescent layer 142 is formed through printing method, silkscreen method, etc.

FIG. 9B is a cross-sectional view illustrating a second substrate.

Referring to FIG. 9B, a second substrate 112 including an optically transparent material such as glass is cut out to have a rectangular plate shape. An area and a shape of the second substrate 112 are substantially same as an area and a shape of the first substrate 111 in FIG. 9A.

A second main region SMR and a second sub region SSR are alternatingly formed on a surface of the second substrate 112. The second main region SMR of the second substrate 112 faces the first main region FMR of the first substrate 111, and the second sub region SSR of the second substrate 112 faces the first sub region FSR of the first substrate 111.

In the present embodiment, the first substrate 111 may be firstly formed, and then the second substrate 112 may be formed, or vice versa.

FIG. 9C is a plan view illustrating a partition member formed on the second substrate in FIG. 9B, and FIG. 9D is a cross-sectional view taken along a line B₁-B₂ in FIG. 9C.

Referring to FIGS. 9C and 9D, a partition member 120 is formed in a second sub region SSR of a second substrate 112. The partition member 120 is extended in a second direction, and a plurality of the partition members 120 may be arranged in parallel with each other along a first direction that is substantially perpendicular to the second direction to form a plurality of discharge spaces 114 having a first length. The partition member 120 has a second length that is less than the first length to form a passage that connects between the discharge spaces 114.

The partition member 120 may be formed via a dispenser ejecting ceramic material into a form of a wall-shape on the second substrate 112, or the partition member 120 may be formed via a mould having cavity filled with the ceramic material, wherein the cavity has a shape corresponding to the partition member 120.

A fixing boss 124 is formed in the passage 122 by the ceramic material. Both the partition member 120 and the fixing boss 124 may be formed simultaneously.

When the partition member 120 is formed, a light reflection layer 144 may be formed on another region of the second substrate 112 other than a second enclosing region SER, and a second fluorescent layer 143 is formed on the light reflection layer 144. A portion of the light reflection layer 144 and the second fluorescent layer 143, which is disposed on the partition member 120, may be removed.

FIG. 9E is a plan view illustrating a providing member combined with the fixing boss.

Referring to FIG. 9E, a proving member 130 that provides a discharge space 114 with operation gas containing mercury (Hg) is combined with the fixing boss 124. The proving member 130 may have a ring shape or a cylindrical shape.

FIG. 9F is a cross-sectional view illustrating the first and second substrates assembled together.

Referring to FIG. 9F, the first substrate 111 and the second substrate 112 having the partition member 120 and the providing member 130 combined with a fixing boss are assembled together by a sealing member 113 interposed between the first and second substrates 111 and 112. An adhesive combines the sealing member 113 with the first substrate 111 or the second substrate 112. The partition member 120 may be combined with the first substrate 111 by the adhesive.

FIG. 9G is cross-sectional view illustrating the providing member that provides the discharge space with the operation gas.

Referring to FIG. 9G, when first and second substrates 111 and 112 are assembled together, the providing member 130 interposed between the first and second substrates 111 and 112 is heated. For example, the providing member 130 may be heated by high frequency wave generated from a high frequency generator 10.

When the providing member 130 is heated to be in a temperature range of about 500° C., to 600° C., the operation gas is released from the providing member 130 to be provided to the discharge space 114.

Then, a discharge voltage applying member is formed on one of the first and second substrates 111 and 112.

Embodiment 4

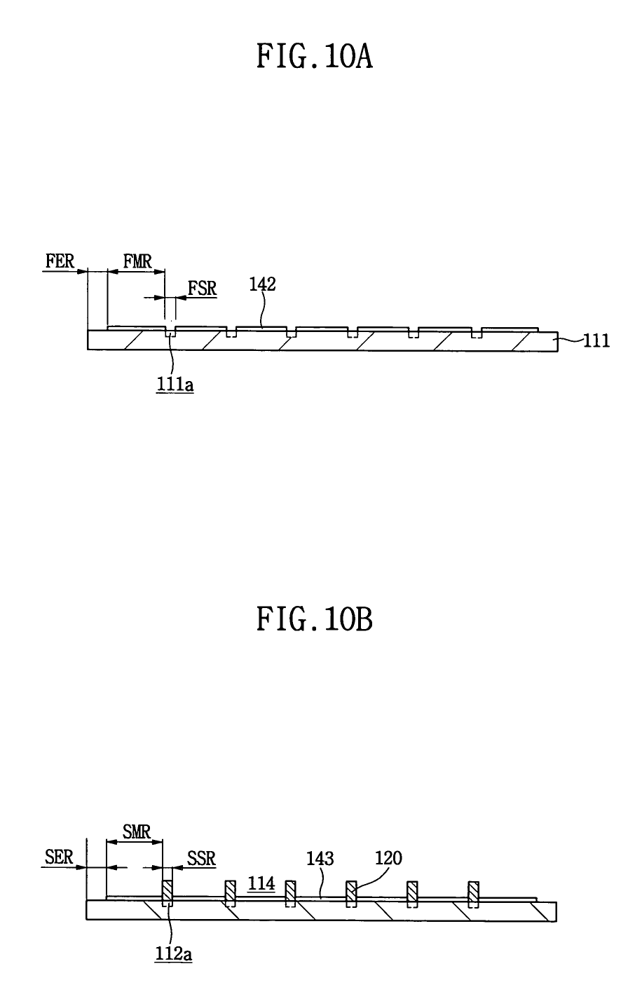

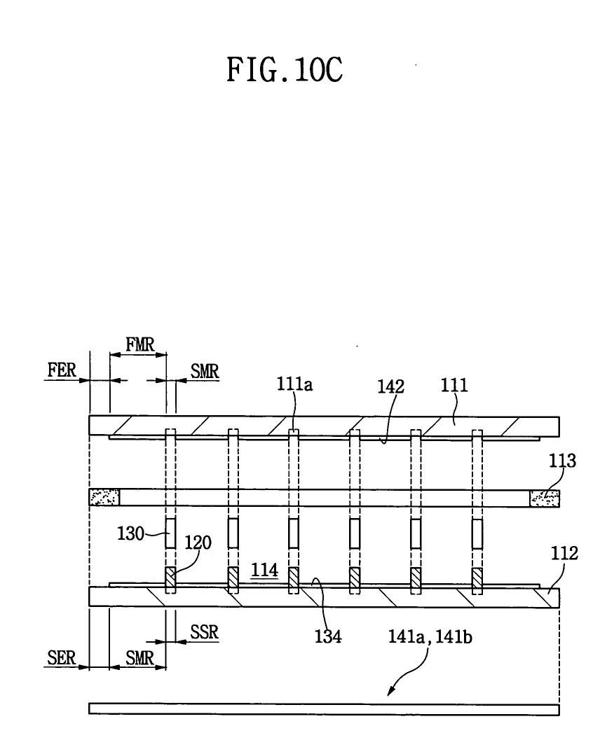

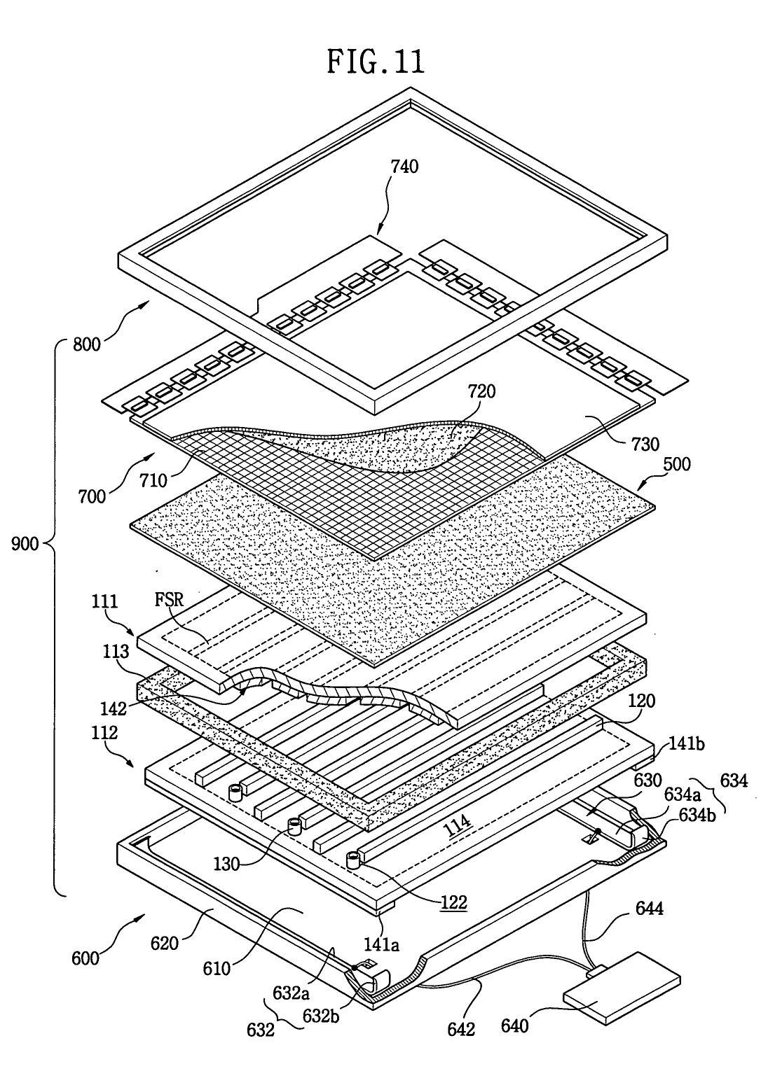

FIGS. 10A to 10C are cross-sectional views illustrating a process of manufacturing a surface light source device according to a fourth exemplary embodiment of the present invention.

FIG. 10A is a cross-sectional view illustrating a first substrate manufactured according to a fourth exemplary embodiment of the present invention.

Referring to FIG. 10A, a first fluorescent layer 142 is formed in a first main region FMR of a first substrate 111, and a first connection recess 111a is formed in a first sub region FSR disposed between the first main regions FMR.

FIG. 10B is a cross-sectional view illustrating a second substrate manufactured according to a fourth exemplary embodiment of the present invention.

Referring to FIG. 10B, a second fluorescent layer 143 is formed in a second main region SMR of a second substrate 112. A second connection recession 112a is formed in the second sub region SSR, such that the second connection recession 112a faces the first connection recession 111a of the first substrate 111 in FIG. 10A.

Then, a partition member 120 is inserted into the second connection recession 112a, such that a passage may be formed. The partition member 120 may be formed via a dispenser ejecting a ceramic material into a form of a wall-shape in the second sub region SSR, or the partition member 120 may be formed via a mould having cavity filled with the ceramic material, wherein the cavity has a shape corresponding to the partition member 120.

FIG. 10C is a cross-sectional view showing an assembly of the first and second is substrates.

Referring to FIG. 10C, the first and second substrates 111 and 112 are disposed, such that first and second fluorescent layers 142 and 142 face each other, and a sealing member 113 is interposed between the first and second substrates 111 and 112. The sealing member 113 is disposed in a first enclosing region FER of the first substrate 111 and a second enclosing region SER of the second substrate 112, and a providing member 130 is disposed between a first connection recess 111a of the first substrate 111 and a second connection recess 112a of the second substrate 112.

Then, the first and second substrates 111 and 112 are assembled together by the sealing member 113. A first end of the providing member 130 is inserted into the first connection recess 111a of the first substrate 111, and a second end of the providing member 130 is inserted into the second connection recess 112a of the second substrate 112, so that the providing member 130 is fixed.

Then, a high frequency wave is applied to the providing member 130, so that the providing member 130 is heated by the high frequency wave generated from a high frequency generator 10.

When the providing member 130 is heated to be in a temperature range of about 500° C. to 600° C., operation gas is released from the providing member 130 to be provided to a discharge space 114, and impurity gas of the discharge space 114 is absorbed by the providing member 130.

Additionally, first and second electrodes 141a and 141b for applying discharge voltage to the operation gas are attached on the first substrate 111 or the second substrate 112.

Display Apparatus

Embodiment 5

FIG. 11 is an exploded perspective view illustrating a display apparatus according to a fifth exemplary embodiment of the present invention. A surface light source device and a method of manufacturing the surface light source device of the present embodiment are same as in Embodiments 1 to 4. Thus, the same reference numerals will be used to refer to the same or like parts as those described in Embodiments 1 to 4 and any further explanation will be omitted.

Referring to FIG. 11, a liquid crystal display apparatus 900 includes a receiving container 600, a surface light source device 100, a liquid crystal display panel 700 and a chassis 800.

The receiving container 600 includes a bottom plate 610, a plurality of sidewalls 620 formed at edge portion of the bottom plate 610, a discharge voltage applying module 630 and an inverter 640. The receiving container 600 fixes the surface light source device 100 and the liquid crystal display panel 700.

The bottom plate 610 is large enough, so that the surface light source device 100 may be disposed on the bottom plate 610. The bottom plate has a shape corresponding to the surface light source device 100. For example, both the bottom plate 610 and the surface light source device 100 have a rectangular shape.

The sidewall is extended from the edge portion of the bottom plate 610 to fix the to surface light source device 100.

The discharge voltage applying module 630 applies a discharge voltage to first and second electrodes 141a and 141b of the surface light source device 100. The discharge voltage applying module 630 includes first and second discharge voltage applying modules 632 and 634. The first discharge voltage applying module 632 includes a first conducting body 632a and a first conducting clip 632b formed at the first conducting body 632a. The second discharge voltage applying module 634 includes a second conducting body 634a and a second conducting clip 634b formed at the second conducting body 634a.

The first and second electrodes 141a and 141b of the surface light source device 100 are combined with the first and second conducting clips 632b and 634b, respectively, to be fixed.

The inverter 640 applies first and second discharge voltages to the first and second discharge voltage applying modules 632 and 634. The inverter 640 is electrically connected to the first discharge voltage applying module 632 by a first wire 642, and the inverter 640 is electrically connected to the second discharge voltage applying module 634 by a second wire 644. The first and second wires 642 and 644 may be directly connected to the first and second electrodes 141a and 141b, respectively.

The liquid crystal display panel 700 converts a light generated from the surface light source device 100 into an image light. The liquid crystal display panel 700 includes a thin film transistor substrate 710, a liquid crystal layer 720, a color filter substrate 730 and a driving module 740.

The thin film transistor substrate 710 includes pixel electrodes arrange in a matrix shape, thin film transistors that apply a driving voltage to the pixel electrodes, respectively, gate lines and data lines.

The color filter substrate 730 includes color filters facing the pixel electrode of the thin film transistor substrate 710, and a common electrode formed on the color filters.

The liquid crystal layer 720 is interposed between the thin film transistor substrate 710 and the color filter substrate 730.

The chassis 800 surrounds edge portion of the liquid crystal display panel 700, and the chassis 800 is combined with the receiving container 600. The chassis 800 fixes and protects the liquid crystal display panel 700.

A light diffusion sheet 500 may be interposed between the surface light source device 100 and the liquid crystal display panel 700 in order to enhance display quality.

According to the present invention, an opening for providing operation gas to a discharge space and sealing process after the operation gas is provided are not required. Therefore, process of manufacturing the surface light source device may be simplified to enhance productivity.

Having described the exemplary embodiments of the present invention and its advantages, it is noted that various changes, substitutions and alterations can be made herein without departing from the spirit and scope of the invention as defined by appended claims.

1. A surface light source device comprising:
a body including a first substrate having a first main region and a first sub region, wherein the first main region and the first sub region are alternatingly formed, and a second substrate having a second main region facing the first main region and a second sub region facing the first sub region;
a partition member interposed between the first and second sub regions to form discharge spaces between the first and second main regions, the partition member having a passage that connects between the discharge spaces;
a first providing member disposed on the passage, the providing member providing the discharge space with operation gas; and
a visible light generating unit that generates a visible light from the operation gas of the discharge spaces.

2. The surface light source device of claim 1, wherein the discharge spaces have a first length, and the partition member has a second length that is less than the first length to form the passage.

3. The surface light source device of claim 1, wherein the first providing member comprises an absorption member that absorbs impurity gas in the discharge spaces.

4. The surface light source device of claim 1, wherein the body further comprises a fixing boss that is disposed at the passage and fixes the first providing member.

5. The surface light source device of claim 4, wherein the fixing boss is inserted into the first providing member having a ring shape.

6. The surface light source device of claim 1, wherein the fixing boss and the partition member comprise same material.

7. The surface light source device of claim 1, wherein the fixing boss comprises a different material from the partition member.

8. The surface light source device of claim 1, wherein the first providing member generates the operation gas when the providing member is heated.

9. The surface light source device of claim 1, wherein the second substrate comprises a connection recess formed in the second sub region corresponding to the passage, the first providing member includes a first end portion and a second end portion that is opposite to the first end portion, the first end portion makes contact with the first sub region of the first substrate and the second end portion is inserted into the connection recess.

10. The surface light source device of claim 1, wherein the first and second substrates comprise a first connection recess and a second connection recess facing the first connection recess, respectively, and a first end portion of the first providing member is inserted into the first connection recess and a second end portion of the providing member is inserted into the second connection recess.

11. The surface light source device of claim 1, further comprising a second providing member, the first and second providing members being disposed at each end portion of the discharge space, respectively.

12. The surface light source device of claim 1, wherein the visible light generating unit comprises:
a pair of electrodes disposed outer surface of the body to apply discharge voltage to the operation gas in order to generate an invisible light; and
a first fluorescent layer formed in the first main region, the first fluorescent layer converting the invisible light into the visible light.

13. The surface light source device of claim 12, wherein the visible light generating unit further comprises a second fluorescent layer disposed in the second main region, the second fluorescent layer converts the invisible light into the visible light.

14. The surface light source device of claim 13, further comprising a light reflection layer interposed between the second substrate and the second fluorescent layer.

15. The surface light source device of claim 12, wherein the electrodes are substantially perpendicular to the partition member, and the electrodes are disposed at both end portions of the discharge space, respectively.

16. The surface light source device of claim 1, wherein at least two pieces of the partition members are included, the two pieces of the partition members being separated from each other to form the passage.

17. A method of forming a surface light source device, comprising:
forming a first substrate having a first main region and a first sub region alternating with each other;
forming a second substrate having a second main region facing the first main region, and a second sub region facing the first sub region;
forming a partition member on the second sub region to form discharge spaces corresponding to the first and second main regions, the partition member having a passage connecting between the discharge spaces;
forming a providing member disposed at the passage, the providing member providing the discharge spaces with operation gas; and
assembling the first and second substrates.

18. The method of claim 17, further comprising forming a fixing boss that fixes the providing member at the passage.

19. The method of claim 17, wherein the first substrate comprises a first fluorescent layer formed at the first main region.

20. The method of claim of claim 17, wherein the second substrate comprises a reflection layer and a second fluorescent layer formed on the reflection layer.

21. The method of claim 17, wherein the first providing member generates the operation gas when the providing member is heated.

22. The method of claim of claim 17, further comprising forming electrodes on the first substrate.

23. The method of claim 17, wherein the first and second substrates comprise a first connection recess and a second connection recess facing the first connection recess, respectively, and a first end portion of the first providing member is inserted into the first connection recess and a second end portion of the providing member is inserted into the second connection recess when the first and second substrates are assembled together.

24. A display apparatus comprising:
a surface light source device including a body having a space, a partition member disposed in the space to form a plurality of discharge spaces and the partition member having a passage connecting between the discharge spaces, a providing member disposed at the passage and the providing member providing the discharge spaces with operation gas, and a visible light generating unit that generates a visible light from the operation gas of the discharge space; and
a display panel that converts the visible light generated from the surface light source device into an image light containing information.
